(19) United States
(12) Patent Application Publication
(10) Pub. No.: US 2015/0103187 A1
(43) Pub. Date: Apr. 16, 2015

(54) Method and System for Adjusting Performance of Video Camera for Thermal Control

(71) Applicant: Sensormatic Electronics, LLC, Boca Raton, FL (US)

(72) Inventors: Steven W. Schieltz, Boca Raton, FL (US); Walter A. Martin, Ballymena (GB)

(21) Appl. No.: 14/052,528

(22) Filed: Oct. 11, 2013

(51) Int. Cl. H04N 5/232; H04N 17/00

(52) U.S. Cl. CPC H04N 5/23245; H04N 17/002
USPC 348/187

(57) ABSTRACT

A system and method for adjusting operating parameters of a video camera in response to detected temperatures uses temperature sensors that detect temperatures of the components within the video camera and an external temperature for an area surrounding the video camera. These temperatures are combined to determine an operating temperature of the video camera. Then, operating parameters of the video camera are adjusted to ensure that the operating temperature of the video camera does not create an over-temperature condition.

### BACKGROUND OF THE INVENTION

Video surveillance cameras are often used for monitoring areas inside or outside buildings. These areas often include parking lots, retail establishments, medical or educational facilities, or government or office buildings, to list a few examples. The video cameras capture video images from the monitored areas and then send those video images to a control system, a monitoring station, and/or a network video recorder (NVR). The video images can also be processed and/or stored on-board the cameras.

The video cameras are often installed in different environments and are thus subjected to a wide range of ambient temperatures. While some environments are climate controlled (e.g., department stores), many environments exhibit large swings in temperature. For example, video cameras that are installed in factories or at outdoor parking lots can be exposed to temperatures that often exceed 100 degrees Fahrenheit (40 degrees Celsius).

Additionally, components of the video cameras often generate a significant amount of heat during operation. For example, microprocessors, video image sensors (imagers), video processors, and external memory generate significant heat during operation. Other components such as video compression circuits or chips, power controllers, or infrared illuminators will also produce heat during operation.

The combination of the external ambient temperatures of areas surrounding the video cameras and the heat generated by the components of the video cameras governs the operating temperatures of the video cameras.

Generally, the components of the video cameras have high temperature specifications, which are typically are set by manufacturers of the components and specify maximum operating temperatures of the components. Exceeding the high temperature specifications may cause the components to work incorrectly or even fail. Additionally, allowing the components to exceed the high temperature specifications for extended periods of time may reduce their operating lifetimes.

### SUMMARY OF THE INVENTION

One solution for operating in environments subjected to extreme temperatures is to specify components with higher maximum operating temperatures. For example, industrial, automotive, or military grade components typically have higher maximum operating temperatures than commercial grade components. This solution is generally not economical for commodity cameras, however, because the industrial, automotive, or military grade components are typically 20-30% more expensive than the commercial grade components. Additionally, the required industrial, automotive, or military grade components may not be even available.

Another solution is to implement forced cooling with fans. The fans are able to cool the components by drawing in air into the video camera and expelling warm air from the video camera. However, fans may not provide enough cooling to ensure that the components do not exceed the high temperature specifications. Additionally, there may be reliability issues with a mechanical cooling system. For example, if a fan malfunctions, the temperature within the video camera will rise and exceed the high temperature specifications. This creates an over-temperature condition that could damage the components or the video cameras.

The present system and method are directed to adjusting operating parameters of the video camera in response to detected temperatures. Specifically, the video camera includes one or more temperature sensors that detect temperatures of the components within the video camera and/or temperature related to the external ambient temperature for the video camera. Then, the operating parameters of the video camera are adjusted to prevent the operating temperature from creating an over-temperature condition.

In general, according to one aspect, the invention features a thermal control method for a video camera. The method includes detecting a temperature for the video camera. Next, operating parameters of the video camera are adjusted in response to determining that the components within the video camera are at risk of an over-temperature condition based on the detected temperature.

In general, according to another aspect, the invention features a video camera including one or more sensors for detecting temperatures associated with the video camera. The video camera further includes a controller for adjusting operating parameters of the video camera in response to determining that components within the video camera are at risk of an over-temperature condition based on the detected temperatures.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram illustrating a video camera that includes temperature sensors to detect ambient temperatures and temperatures of components of the video camera.

FIG. 2 is a block diagram illustrating an alternative embodiment of the video camera that includes temperature sensors installed on many of the components of the video camera.

FIG. 3 is a flowchart illustrating the steps to adjust operating parameters of the video camera.

FIG. 4 is a flowchart illustrating an alternative embodiment to adjust operating parameters of the video camera that further includes monitoring temperature cycles of the video camera and updating a lookup table.

FIG. 5 illustrates an example of a lookup table for predicting required performance adjustments to the operating parameters of the video camera.

FIG. 6 is a system feedback diagram that shows a feedback control algorithm of the video camera.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms of the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

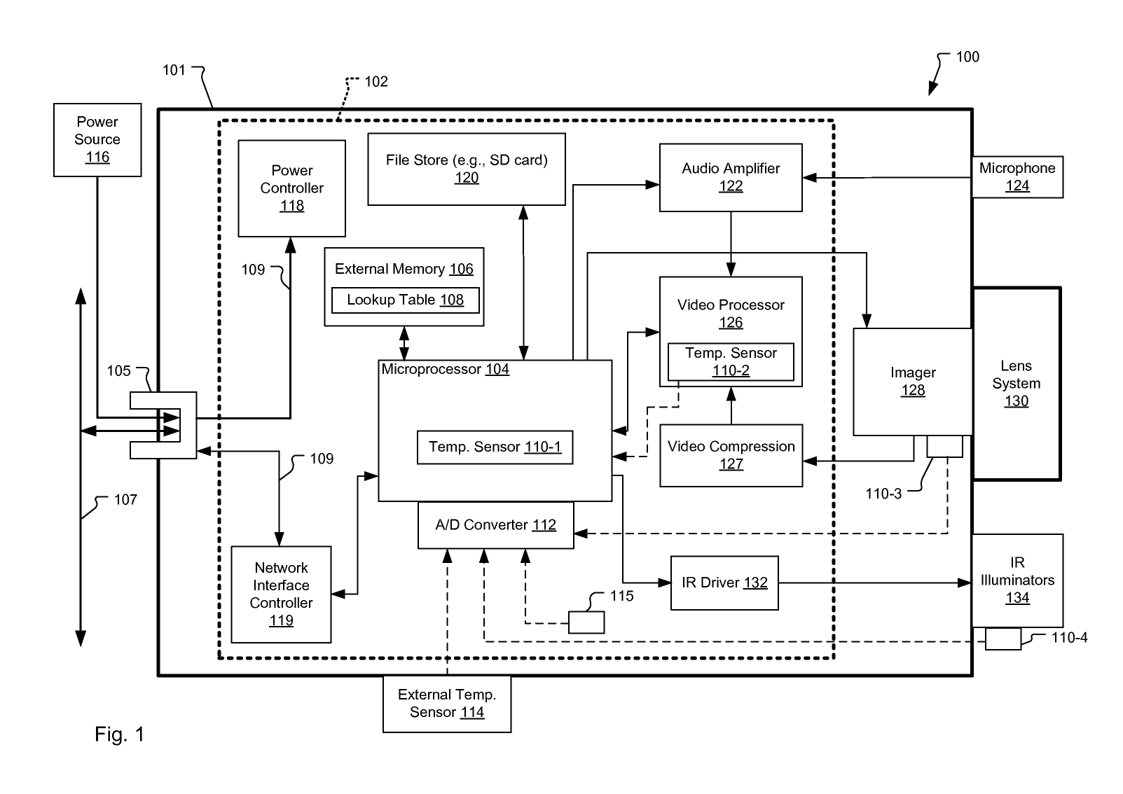

FIG. 1 is a block diagram illustrating a video camera system (video camera) 100 that includes temperature sensors 110-1 to 110-4, 114, 115 to detect temperatures of the components or integrated circuits and ambient temperatures of the video camera 100.

In general, the temperature sensors detect temperatures of the components within the video camera 100 and an external ambient temperature of the air surrounding the video camera and/or the housing 101. The detected temperatures of the components are combined with the detected ambient temperature to determine an operating temperature of the video camera 100, in one example. If the video camera 100 or its components are at risk of an over temperature condition, then operating parameters of the video camera are adjusted to prevent an over-temperature condition.

There are many different temperature sensors that are known in the art. Some common types of temperature sensors include thermocouples, resistive temperature devices, thermistors, and integrated digital temperature sensors, to list a few examples. In a current implementation, the temperature sensors are a combination of integrated digital temperature sensors and thermistors.

In a typical implementation, the video camera system 100 includes the camera housing (or enclosure) 101. The enclosure protects the components of the video camera 100 from weather, tampering, and vandalism. Generally, the enclosure 101 is fabricated from plastics or metal and is weatherproofed to prevent water, dust, or other contaminants from entering the enclosure 101 and damaging the components of the video camera 100.

In the illustrated embodiment, the video camera 100 includes a microprocessor 104, which monitors the temperature sensors (e.g., ref numerals 110-1 to 110-4, 114, 115) and applies an algorithm/lookup table to adjust the operating parameters of the video camera in response to the detected temperatures.

A processor sensor 110-1 monitors the temperature of the microprocessor 104. In the illustrated example, the processor sensor 110-1 is a digital temperature sensor integrated into the microprocessor 104. The processor sensor 110-1 generates a digital output for the detected temperature of the microprocessor 104. In an alternative embodiment, the processor sensor 110-1 could be a thermistor that is installed on or adjacent to the package of the microprocessor 104.

The microprocessor 104 is connected to external memory 106, which stores a lookup table 108. The external memory could be volatile or non-volatile memory. The lookup table 108 is used to predict required performance adjustments of the operating parameters of the video camera 100 based on the detected temperatures of the components, in one embodiment. In some implementations, the lookup table 108 is updated with temperature cycle information and/or installation information of the video camera 100.

The temperature cycle information accounts for changes in the external ambient air temperature that typically occurs throughout the day. Additionally, the temperature cycle information accounts for installation factors such as the video camera 100 being installed in direct or partial sunlight or near a heat source. The installation factors may also account for variations encountered during the manufacturing of the components, which may cause individual components to operate hotter than would be predicted by the manufacturer's specifications.

The microprocessor 104 is also connected to a file store 120, in one embodiment. The file store 120 is typically non-volatile storage such as a secure digital (SD) card, a hard disk drive, or a solid state drive, to list a few examples. The file store 120 may store backup versions of the lookup table, other software executed by the microprocessor 104, or video images captured by the video camera (i.e., video data), to list a few examples.

An analog-to-digital (or A/D) converter 112 is connected to the microprocessor 104. The A/D converter 112 receives analog signals from temperature sensors and converts the received analog signals into digital temperatures. These digital temperatures are then monitored by the microprocessor 104.

A camera electronics control (CEC) temperature sensor 115 is installed on a camera electronics control (CEC) board 102. The CEC temperature sensor 115 detects an overall temperature of the video camera 100. This overall temperature is then sent to the A/D converter 112.

To reduce confusion in the figure, connections between the temperature sensors (e.g., 110-2, 110-3, 110-4, 114, 115) and the A/D converter 112 are shown as arrows with dashed lines.

The CEC board 102 is typically a printed circuit board (PCB) that provides mechanical support and electrical connections for the components mounted on the CEC board 102.

The video camera 100 includes an external temperature sensor 114. This sensor 114 detects an external ambient temperature or a temperature that is a function of the ambient temperature.

In the illustrated embodiment, the external temperature sensor 114 is attached to the exterior of the camera enclosure 101. In an alternative embodiment, the external temperature sensor 114 is installed directly inside the enclosure 101. In this embodiment, a temperature sensor would be mounted inside the video camera 100 and away from the heat generating components (e.g., the microprocessor 104, an imager 128, and a video processor 126) of the video camera 100.

The video camera 100 further includes a lens system 130, which typically has one or more optics and a focusing mechanism. The different optics and focusing mechanism enable the lens system 130 to capture different fields of view. For example, the lens system 130 may implement optics for a fixed field of view, wide angle viewing, or zooming, to list a few examples. The lens system 130 captures light and directs it to a video image sensor (referred to as an imager or imager circuit) 128.

The imager 128 converts the captured light into a series of electronic images (i.e., video data). Generally, the imager 128 is a charge-coupled device (CCD) or a complementary metal-oxide-semiconductor (CMOS) device. The imager 128 is typically mounted on a separate printed circuit board from the CEC board 102 because the imager 128 needs be installed directly behind the lens system 130 to receive the captured light from the lens system 130.

An imager temperature sensor 110-3 is connected to the imager 128 to detect the temperate of the imager 128. In one embodiment, the temperature sensor 110-3 is thermistor that is installed on or adjacent to the imager 128. The detected temperature is sent to the A/D converter 112.

The video data generated by the imager 128 is sent to a video compression circuit or chip 127. The video compression circuit 127 reduces the size of the video data, which makes the video data easier to store, analyze, and/or stream over a network.

The compressed video data are then sent to a video processor 126 to be analyzed and/or further processed. In a current implementation, the video processor 126 combines the video data with corresponding audio captured by a microphone 124.

A video processor temperature sensor 110-2 detects the temperature of the video processor 126. In the illustrated example, the video processor temperature sensor 110-2 is an integrated digital temperature sensor that sends the detected (digital) temperature directly to the microprocessor 104. In an alternative embodiment, the video processor temperature sensor 110-2 is a thermistor that sends an analog signal to the A/D converter 112.

In the illustrated embodiment, the microprocessor 104, the video compression chip 127, and video processor 126 are separate components. In an alternative embodiment, the microprocessor and video compression are a single integrated circuit, which may also include a video processor that performs both the video compression and microprocessor functions.

The microphone 124 captures audio and sends it to an audio amplifier circuit 122. The audio amplifier circuit 122 amplifies the captured audio. Additionally, the audio amplifier circuit 122 may filter unwanted noise and interference from the captured audio. The audio is then sent to the video processor 126 and combined with the corresponding video data from the imager 128.

In a current implementation, the video camera 100 includes infrared (IR) illuminators 134 and an IR driver circuit 132. The IR driver circuit 132 controls the IR illuminators 134, which enable the video camera 100 to operate in darkness and/or low light conditions.

An infrared (IR) temperature sensor 110-4 detects a temperature of the IR illuminators 134. The IR temperature sensor 110-4 is typically a thermistor that is installed on or adjacent to the IR illuminators 134. The detected temperature information from the IR temperature sensor 110-4 is sent to the A/D converter 112.

A network interface controller (NIC) 119 enables the video camera 100 to communicate over a network 107. The NIC 119 enables the video data to be transmitted over the network 107 to a control system, a monitoring station, and/or a network video recorder (not illustrated). The network 107 is typically a public and/or private data network such as the Internet. The network may also include an enterprise network, university network, government network, and/or mobile broadband data network, to list a few examples.

A power controller 118 provides power to the component of the video camera 100. In operation, electrical connections exist between the power controller 118 and each component of the video camera 100 that needs power. To maintain clarity within the figure, the power distribution connections between the power controller 118 and the components of the video camera are not illustrated.

The video camera 100 receives power from a power source 116. In a current implementation, the video camera implements power over Ethernet. This allows data and power to be transferred over a single network cable. The network cable connects to a network port 105 of the video camera. From the network port, the power is sent to the power controller 118 via a power connection path 109 and data are sent to the network interface controller 119 via the network connection path 111.

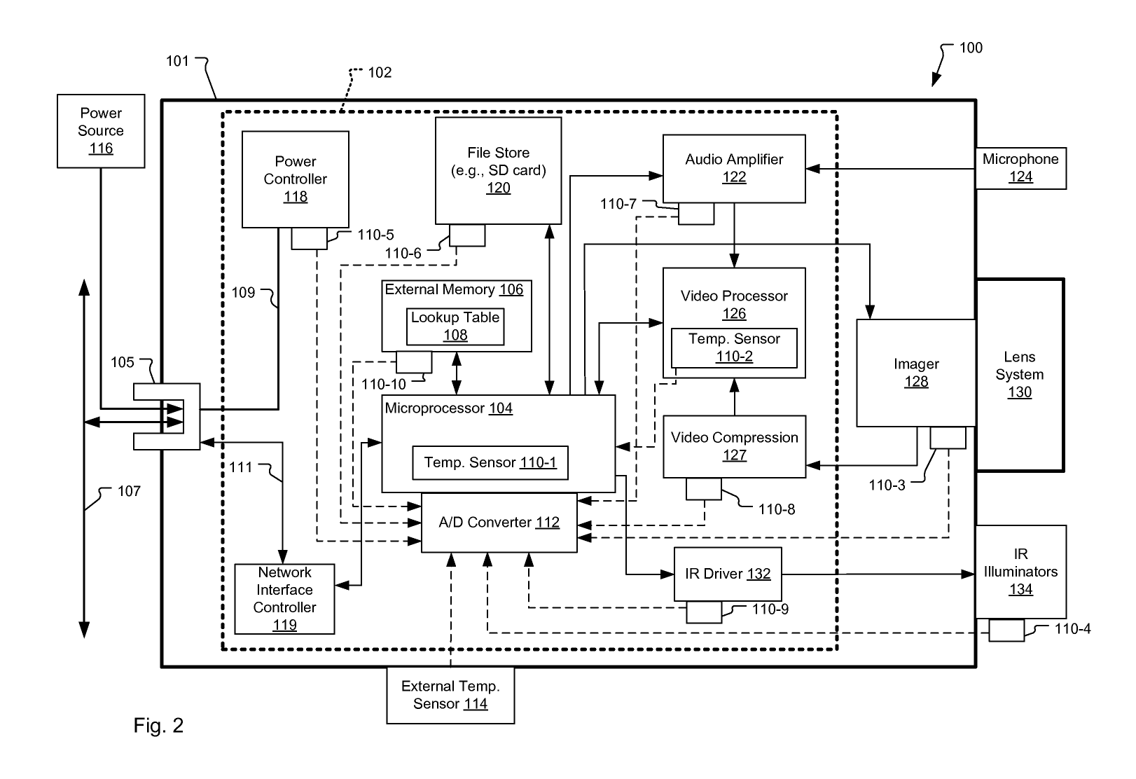

FIG. 2 is a block diagram illustrating an alternative embodiment of the video camera 100 that includes temperature sensors installed on many of the components of the video camera 100.

In general, the overall operation and functionality of this embodiment is nearly identical to the embodiment described with respect to FIG. 1. In this embodiment, however, temperature sensors are installed on many of the illustrated components of the video camera 100. For example, in addition to the temperature sensors described with respect to FIG. 1, a power controller sensor 110-5 is installed on the power controller 118, a file store sensor 110-6 is installed on the file store 120, an audio amplifier sensor 110-7 is installed on the audio amplifier 122, a video compression sensor 110-8 is installed on the video compression circuit 127, an IR driver sensor 110-9 is installed on the IR driver 132, and a memory sensor 110-10 is installed on the external memory 106. Installing the temperature sensors on many of the components enables more accurate temperature information to be detected because each component's temperature is detected individually.

The CEC temperature sensor (ref numeral 115 in FIG. 1), which detected an overall temperature of the video camera 100, is not implemented in this embodiment, but could be in alternative implementations.

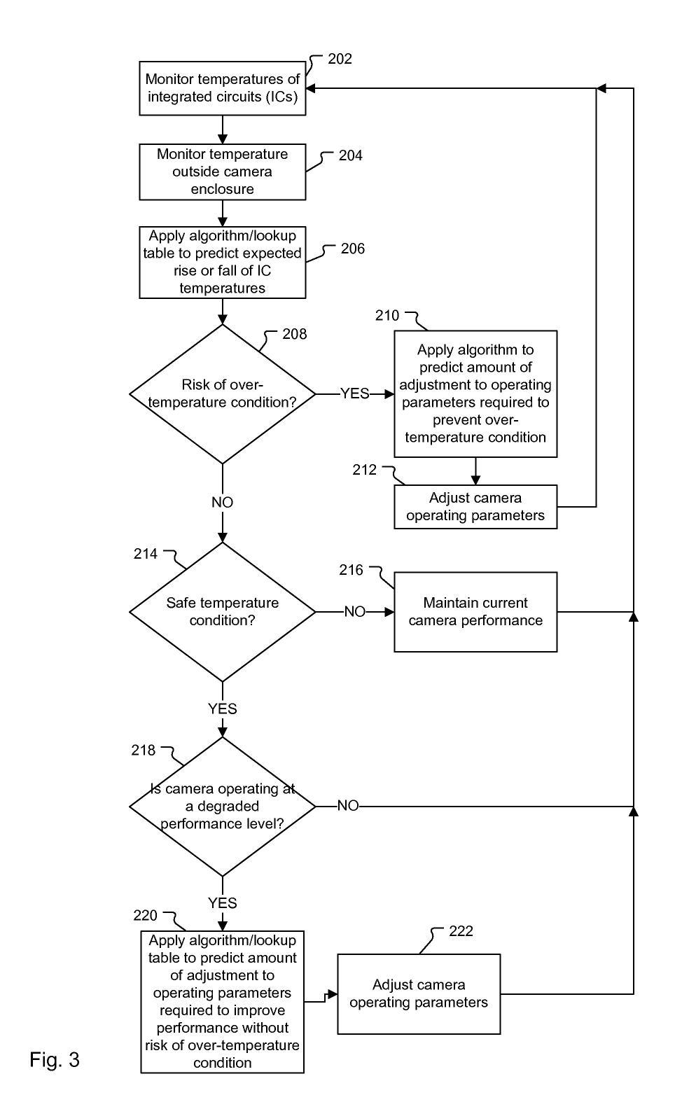

FIG. 3 is a flowchart illustrating the steps to adjust operating parameters of the video camera 100.

In the first step 202, the microprocessor 104 monitors temperatures of the components (or integrated circuits) of the video camera 100. Similarly, in step 204, the microprocessor 104 monitors an external temperature of an area surrounding the video camera 100. The microprocessor 104 then applies an algorithm/lookup table to predict an expected rise or fall of the temperatures of the integrated circuits based on the detected temperatures in step 206.

In the next step 208, the microprocessor 104 determines if the video camera 100 is at risk of an over-temperature condition. If the video camera 100 is at risk of an over-temperature condition, then the microprocessor 104 applies the algorithm to predict an amount of adjustments to the operating parameters that is required to prevent the over-temperature condition in step 210. In the next step 212, the camera's operating parameters are adjusted.

In a current implementation, adjusting the operating parameters of the video camera 100 includes one or more of reducing a video resolution of captured video data, reducing a number of images per second captured by the imager 128, or changing a video quality (compression) of the video data.

In alternative embodiments, adjusting the operating parameters may further or alternatively include one or more of the following: reducing a clock rate of the microprocessor 104, reducing or eliminating audio capabilities of the video camera 100, reducing or eliminating access to the file store 120, reducing a data transmission rate (e.g., forcing the physical layer (PHY) to transmit at 10 or 100 Mbps instead of 1,000 Mbps (or “GigE”)), and/or reducing a duty cycle of or intensity of light generated by the infrared illuminators 134.

Returning to step 208, if the video camera 100 is not at risk of an over-temperature condition, then the microprocessor 104 determines if the video camera is operating in a safe temperature condition in step 214. The safe temperature condition refers to a temperature condition that is below an ideal temperature condition of the components. The ideal temperature condition is an optimum temperature range between the safe temperature condition and the over-temperature condition.

If the components of the video camera 100 are not operating in a safe temperature condition (i.e., within the ideal temperature condition), then the microprocessor 104 maintains current camera performance in step 216. The current camera performance is maintained because the video camera 100 is not at risk of the over-temperature condition or the safe-temperature condition. In this scenario, the operating parameters maintain their current performance, even if the operating parameters could operate at higher temperatures. This is to prevent sudden changes in the detected temperature from causing oscillations (i.e., back and forth swings) to the camera's performance.

Returning to step 214, if the video camera 100 is operating in a safe temperature condition, then the microprocessor 104 determines if the video camera 100 is operating at a degraded performance level in step 218. If the video camera 100 is not operating at a degraded performance level, then the microprocessor 104 continues to monitor the temperature sensors in step 202.

If the video camera 100 is operating at a degraded performance level, then the microprocessor 104 applies the algorithm/lookup table to predict the amount of adjustments to the operating parameters that is required to improve the camera's performance without risk of creating an over-temperature condition in step 220. The algorithm provides a balance between the performance of the video camera 100 and the detected temperatures of the components of the video camera 100 to ensure that the video camera 100 is able to operate at the highest performance level without creating an over-temperature condition. In the next step 222, the microprocessor 104 adjusts the camera's operating parameters.

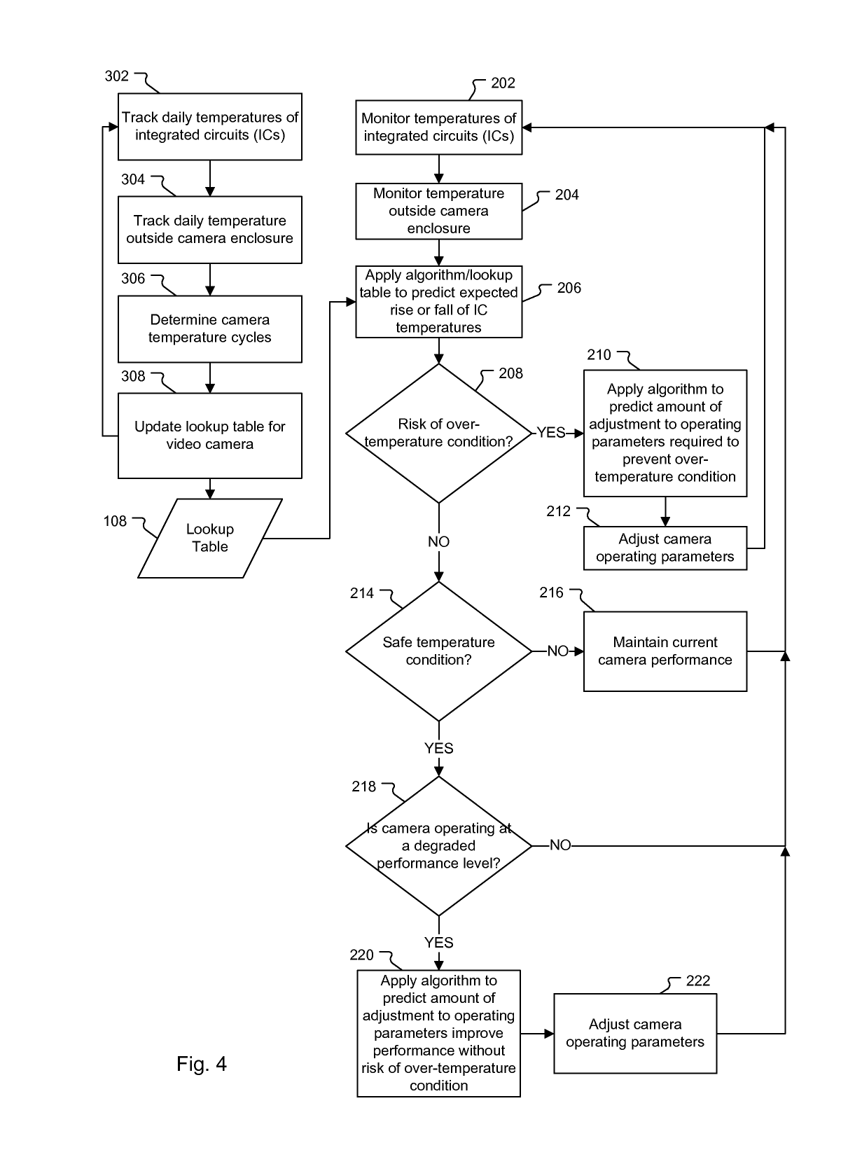

FIG. 4 is a flowchart illustrating an alternative embodiment to adjust operating parameters of the video camera 100 that further includes monitoring temperature cycles of the video camera 100 and updating a lookup table 108.

In the first step 302, the microprocessor 104 tracks daily temperatures of the integrated circuits (or components). Next, the microprocessor 104 tracks daily temperatures outside of the video camera 100 in step 304.

Based on the tracked daily temperatures, the microprocessor 104 determines temperature cycles of the video camera 100 in step 306. Typically, the temperature of the video camera 100 is determined by combining the tracked daily temperature of the components and the tracked daily temperature outside the video camera.

In the next step 308, the lookup table 108 is updated with the temperature cycle information of the video camera 100. This updated lookup table is then accesses by the microprocessor when applying the algorithm to adjust operating parameters of the video camera 100. Steps 202 through 222 are identical to the steps previously described with respect to FIG. 3.

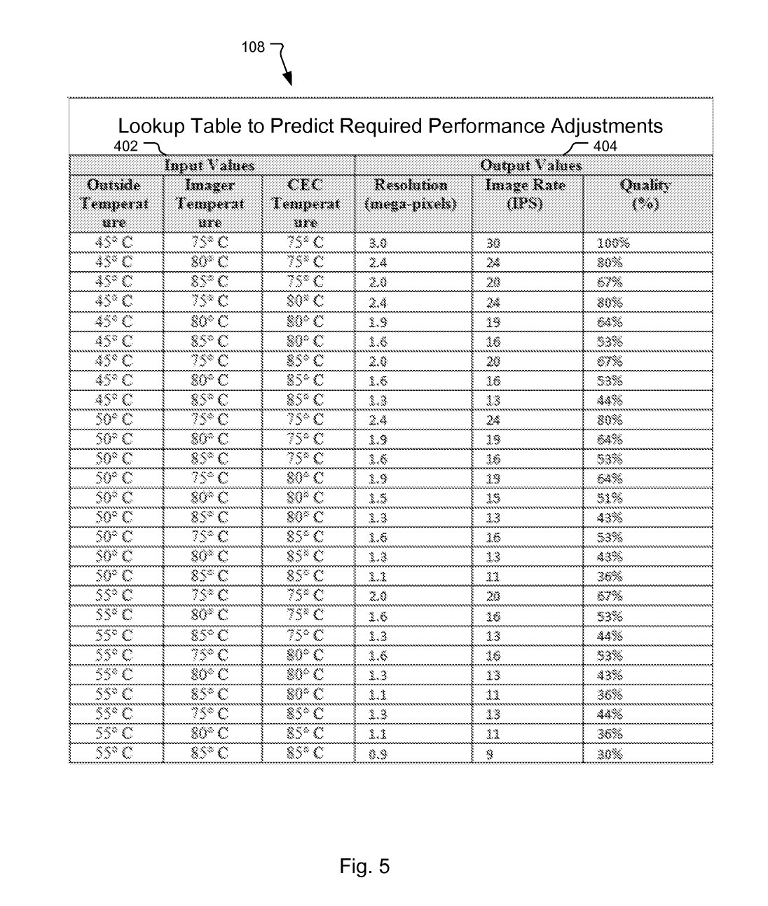

FIG. 5 illustrates an example of a lookup table 108 for predicting required performance adjustments to the operating parameters of the video camera 100.

In the illustrated example, input values 402 (i.e., detected temperatures) include the outside (external) temperature, imager temperature, and CEC board temperature. These temperatures are detected by the external temperature sensor 114, the CEC temperature sensor 115, and imager temperature sensor 110-3, respectively.

The output values 404 (operating parameters) include a video resolution (mega-pixels) of captured video data, image rate (images per second) of the imager 128, and quality (i.e., video data compression).

In an alternative embodiment, additional input values are added to the lookup table 108. For example, the input values of the lookup table 108 could be expanded to include detected temperatures from a power controller sensor 110-5, a file store sensor 110-6, an audio amplifier sensor 110-7, a video compression sensor 110-8, an IR driver sensor 110-9, or a memory sensor 110-10. Similarly, output values may also added to the lookup table 108.

In yet another alternative embodiment, the lookup table 108 could be further expanded via interpolation and/or heuristic values to increase the precision of the input and output values.

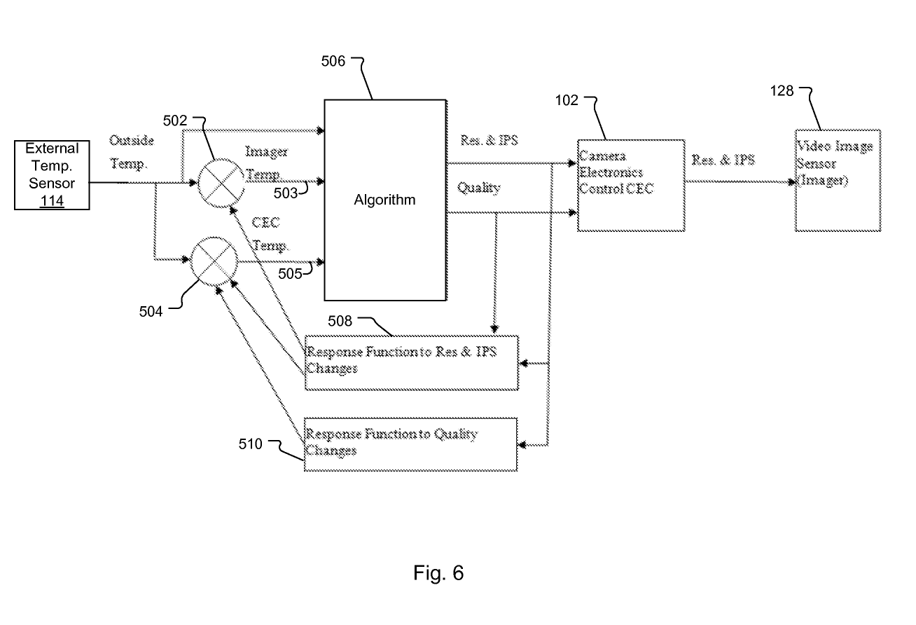

FIG. 6 is a system feedback diagram that shows a feedback control algorithm of the video camera 100. The illustrated embodiment shows an implemented control algorithm, and also the real nature of physics in that the component temperature of the imager 128 and CEC board 102 are a mixed function of the outside temperature and the performance (image per second, resolution, and quality) the chips are run at.

The imager and the CEC board temperatures are “sensed” (i.e., inputted) directly to an algorithm 506. This is illustrated by the arrows (503, 505) from mixers 502 and 504 to the algorithm 506. These arrows 503, 505 represent an actual temperature of the imager 128 and CEC board 102, which are utilized by the algorithm 506.

The mixers 502, 504 each have two inputs: an external temperature as sensed by the external temperature sensor 114 and a performance of a component being operated, both of which are inputs to an actual physical function that determines the temperature of the components. It is this physical function (or principle) that the algorithm 506 is trying to predict and compensate for by adjusting operating parameters to control the temperature of the video camera 100.

Response function blocks 508, 510 respond to changes in the performances.

In general, the mixers 502, 504 and the response function blocks 508, 510 do not represent physical components of the video camera. They represent the physical phenomena for determining the temperatures of the components of the video camera 100.

In a current implementation, the feedback system is a closed loop feedback system that uses control logic and a simple over damped (or critically damped) feedback loop to prevent sudden changes from causing oscillations when adjusting the operating parameters.

While this invention has been particularly shown and described with references to preferred embodiments thereof, it will be understood by those skilled in the art that various changes in form and details may be made therein without departing from the scope of the invention encompassed by the appended claims.

What is claimed is:

1. A thermal control method for a video camera, the method comprising:
detecting a temperature for the video camera; and
adjusting operating parameters of the video camera in response to determining that components within the video camera are at risk of an over-temperature condition based on the detected temperature.

2. The method of claim 1, wherein the step of detecting the temperature comprises detecting an external ambient temperature for an area surrounding the video camera.

3. The method of claim 1, wherein the step of detecting the temperature comprises detecting a temperature of a microprocessor of the video camera.

4. The method of claim 1, wherein the step of detecting the temperature comprises detecting a temperature of an imager of the video camera.

5. The method of claim 1, wherein adjusting the operating parameters includes reducing a video resolution of video data.

6. The method of claim 1, wherein adjusting the operating parameters includes reducing a number of images per second captured by an imager of the video camera.

7. The method of claim 1, wherein adjusting the operating parameters includes changing a video compression of video data by the video camera.

8. The method of claim 1, wherein adjusting the operating parameters includes reducing a clock rate of a microprocessor of the video camera.

9. The method of claim 1, wherein adjusting the operating parameters includes one or more of the following: a reduction or elimination of audio capability, a reduction or elimination of a file storage device, a reduction of a duty cycle of an infrared illuminator, and/or a reduction of a data transmission rate.

10. The method of claim 1, further comprising adjusting the operating parameters to improve the performance of the video camera in response to determining that the components within the video camera are in a safe temperature condition based on the detected temperature of the video camera.

11. The method of claim 1, further comprising tracking temperatures of the components over time and changing how the video camera adjusts the operating parameters in response to the detected temperature.

12. The method of claim 11, wherein changing how the video camera adjusts the operating parameters in response to the detected temperature comprises updating a lookup table.

13. A video camera, comprising:
one or more sensors for detecting temperatures associated with the video camera; and
a controller for adjusting operating parameters of the video camera in response to determining that components within the video camera are at risk of an over-temperature condition based on the detected temperatures.

14. The video camera of claim 13, wherein the one or more sensors includes an external sensor that detects external ambient temperatures of the video camera.

15. The video camera of claim 13, wherein the one or more sensors includes a processor sensor that monitors a temperature of a microprocessor of the video camera.

16. The video camera of claim 13, wherein the one or more sensors includes an imager sensor that monitors a temperature of an imager of the video camera.

17. The video camera of claim 13, further comprising an imager, wherein the controller adjusts the operating parameters of the imager to reduce a video resolution of video data from the imager.

18. The video camera of claim 17, wherein the controller further adjusts the operating parameters of the imager to reduce a number of images per second captured by the imager of the video camera.

19. The video camera of claim 13, further comprising a video compression circuit, wherein the controller adjusts the operating parameters of the video compression circuit to change video compression of video data.

20. The video camera of claim 13, further comprising a microprocessor, wherein the controller adjusts the operating parameters of the microprocessor to reducing a clock rate of the microprocessor of the video camera.

21. The video camera of claim 13, wherein the controller adjusts the operating parameters by one or more of the following: a reduction or elimination of audio capability, a reduction or elimination of a file storage device, a reduction of a duty cycle of an infrared illuminator, and/or a reduction of a data transmission rate.

22. The video camera of claim 13, wherein the operating parameters are adjusted to improve the performance of the video camera in response to determining that the components within the video camera are in a safe temperature condition based on the detected temperature of the video camera.

23. The video camera of claim 13, wherein the controller tracks temperatures of the components over time and changes how the video camera adjusts the operating parameters in response to the temperatures.

24. The video camera of claim 23, wherein the controller updates a lookup table in response to the tracked temperatures, which lookup table is used to adjust the operating parameters of the video camera.
